(19) United States
(12) Patent Application Publication
(10) Pub. No.: US 2025/0190180 A1
(43) Pub. Date: Jun. 12, 2025

(54) DEVICE AND METHOD FOR AUTOMATICALLY GENERATING SOURCE CODE

(71) Applicant: ELECTRONICS AND TELECOMMUNICATIONS RESEARCH INSTITUTE, Daejeon (KR)

(72) Inventors: Yu Seung MA, Daejeon (KR); Taeho KIM, Daejeon (KR); Sangyeop YEO, Daejeon (KR)

(73) Assignee: ELECTRONICS AND TELECOMMUNICATIONS RESEARCH INSTITUTE, Daejeon (KR)

(21) Appl. No.: 18/950,579

(22) Filed: Nov. 18, 2024

(30) Foreign Application Priority Data
Dec. 7, 2023 (KR) 10-2023-0176667

(51) Int. Cl. G06F 8/33; G06F 8/41; G06N 3/0455; G06N 3/0475

(52) U.S. Cl. CPC G06F 8/33; G06F 8/427; G06N 3/0455; G06N 3/0475

(57) ABSTRACT

Provided are a device and method for automatically generating source code. The device includes a training data generator that receives first training data consisting of a pair of natural language specification and source code and converts the first training data into second training data consisting of a pair of natural language specification and abstract syntax tree and a large language model trainer that trains a large language model based on the second training data, in which the abstract syntax tree includes structural information and semantic information of the source code.

### CROSS-REFERENCE TO RELATED APPLICATION

This application claims priority to and the benefit of Korean Patent Application No. 10-2023-0176667, filed on Dec. 7, 2023, the disclosure of which is incorporated herein by reference in its entirety.

### BACKGROUND

### 1. Field of the Invention

The present invention relates to a device and method for automatically generating source code, and more particularly, to a device and method for automatically generating source code based on a generative language model.

### 2. Discussion of Related Art

A source code generation model is a technology that uses machine learning to automatically generate program source code according to specifications of code when the specifications are described in natural language. This model is used in various application fields including automatic code completion, bug fixing, and code translation, and is mainly based on a natural language processing technique and a large language model architecture.

However, the source code generation model needs to be trained with data having a form that takes structural and grammatical differences between natural language and source code into account, and there is a problem that existing methods do not sufficiently reflect these differences.

### SUMMARY OF THE INVENTION

The present invention is directed to providing a device and method for automatically generating source code that configures existing training data as training data, which consists of pairs natural language specifications and abstract syntax trees, and trains a large language model on the training data to more accurately learn and reflect a structure of source code to generate high-quality source code.

However, the problem to be solved by the present invention is not limited to the problem described above, and other problems may exist.

According to a first aspect of the present invention, there is provided a method of automatically generating source code, which includes receiving first training data consisting of a pair of natural language specification and source code, inputting the first training data into a training data generator and converting the first training data into second training data consisting of a pair of natural language specification and abstract syntax tree, and training a large language model based on the second training data. In this case, the abstract syntax tree includes structural information and semantic information of the source code.

According to a second aspect of the present invention, there is provided a device for automatically generating source code, which includes a training data generator that receives first training data consisting of a pair of natural language specification and source code and converts the first training data into second training data consisting of a pair of natural language specification and abstract syntax tree and a large language model trainer that trains a large language model based on the second training data. In this case, the abstract syntax tree includes structural information and semantic information of the source code.

According to a third aspect of the present invention, there is provided a method of automatically generating source code, which includes inputting a natural language specification into a pre-trained large language model (hereinafter referred to as a learning large language model) and outputting an abstract syntax tree including structural information and semantic information of source code and inputting the output abstract syntax tree into a source code converter and outputting converted source code. In this case, the learning large language model is trained based on training data consisting of a pair of natural language specification and abstract syntax tree prepared in advance.

According to another aspect of the present invention, there is provided a computer program that causes a device and method for automatically generating source code to be executed and is stored in a computer-readable recording medium.

Other specific details of the present invention are included in the detailed description and accompanying drawings.

In addition, according to an embodiment of the present invention, the work efficiency of developers can be significantly improved in actual application fields. For example, the source code generation technology according to the embodiment of the present invention is useful for quickly generating accurate code prototypes based on functional specifications in early stages of development or refactoring existing code, which has an advantage of allowing programmers to generate more accurate and efficient code in less time.

As a result, according to an embodiment of the present invention, innovative contributions can be made in the field of programming using artificial intelligence, and by reducing the complexity of programming tasks and shortening development time, developers can develop creative and efficient software more quickly.

The effects of the present invention are not limited to the above effects, and other effects that are not mentioned can be clearly understood by those skilled in the art from the above description.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing an example of an abstract syntax tree in an embodiment of the present invention;

FIG. 2 is a diagram for describing a device for automatically generating source code according to an embodiment of the present invention;

FIG. 3 is a diagram illustrating an example of training a transformer having an encoder-decoder structure-based large language model in an embodiment of the present invention;

FIG. 4 is a block diagram of a device (100) for automatically generating source code according to an embodiment of the present invention; and

FIG. 5 is a flowchart of a method of automatically generating source code according to an embodiment of the present invention.

### DETAILED DESCRIPTION OF EXEMPLARY EMBODIMENTS

Advantages and features of the present invention and methods for achieving them will be made clear from embodiments described in detail below with reference to the accompanying drawings. However, the present invention is not limited to the embodiments disclosed below and may be implemented in various different forms. These embodiments are merely provided so that this disclosure will be thorough and complete and will fully convey the scope of the present invention to those of ordinary skill in the technical field to which the present invention pertains, and the present invention is only defined by the scope of the claims.

Terms used herein are for the purpose of describing the embodiments and are not intended to limit the present invention. As used herein, the singular forms also include the plural forms as well unless specifically stated otherwise in the context. The terms “comprise” and/or “comprising” used herein do not preclude the presence or addition of one or more other components in addition to the mentioned components. The same reference numerals refer to the same components throughout the specification, and “and/or” “includes each of the mentioned components and all combinations of one or more of the mentioned components. Although “first,” “second,” etc. are used to describe various components, these components are of course not limited by these terms. These terms are merely used to distinguish one component from another. Therefore, it goes without saying that a first component mentioned below may be a second component within the technical idea of the present invention.

Unless otherwise defined, all terms used in this specification (including technical and scientific terms) may be used with meanings commonly understood by those skilled in the art to which the present invention pertains. In addition, terms defined in commonly used dictionaries are not to be interpreted ideally or excessively unless clearly specifically defined.

In the following, the background in which the present invention was devised will be described first in order to help those skilled in the art to understand the present invention.

The source code generation model is a technology that automatically generates source code written in a programming language mainly using machine learning. The main goal of this model is that when a user describes a specification of code in natural language, the model generates program source code according to that specification. Such a model may be used in a variety of application fields. For example, the model may provide features such as automatic code completion, bug fixing, code translation, etc.

Here, the automatic code completion feature is mainly utilized in integrated development environments (IDEs), and may make a user's work more efficient by suggesting expected code snippets while writing code. In addition, the bug fixing feature is used to automatically detect an error or a defect in code and suggest a correction. The code translation feature is used to convert code written in one programming language to another language.

The current source code generation model is mainly based on a natural language processing technology, and especially utilizes a transformer or generative pre-trained transformer (GPT) architecture, which is a large language model (LLM) architecture. Such a source code generation model learns large code bases to understand programming patterns and generate or suggest appropriate code according to the specification given in natural language. Training data are mainly source codes written in programming languages, and additionally include a natural language specification such as description, comments, or requirements for the code.

However, the existing source code generation technology has the limitation of understanding natural language and source code only as a simple text sequence. There are various differences between natural language and program source code in structure, grammar, and used patterns. Natural language is flexible and has a variety of expression methods and contextual meanings, but program source code should follow strict grammar rules and incorrect syntax or structure in the program source code may cause errors. Therefore, generative language models should be trained according to each characteristic and structure of each language, and needs to be trained in a data format suitable for the relevant domain.

To solve these problems, a device and method for automatically generating source code according to an embodiment of the present invention are characterized in that an LLM is trained on training data consisting of a natural language specification and abstract syntax tree (AST) pair obtained by replacing existing training data, so that the LLM may more accurately learn and reflect a structure of source code to generate high quality source code.

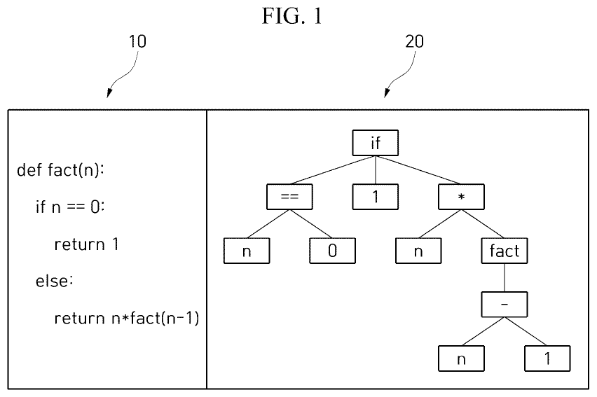

Hereinafter, a device 100 for automatically generating source code according to an embodiment of the present invention will be described with reference to FIGS. 1 to 4.

FIG. 1 is a diagram showing an example of an AST 20 in an embodiment of the present invention.

In an embodiment of the present invention, instead of the existing LLM learning source code 10 in text form, the existing LLM learns an AST 20 that includes structural information and semantic information of source code.

Since the existing LLM only understands and processes source code as a series of text 10, there is a problem that it is difficult to completely understand structural features. However, in the present invention, training of the existing LLM is performed on the AST 20 which represents structural information of the code and is obtained by converting the source code.

In this case, the AST 20 represents a structure of the source code in the form of a tree, and each node represents a component of the code. The AST 20 is a kind of abstract expression and may include a hierarchical structure of code, flow control, variable declaration, etc. Therefore, by learning this AST 20, the model may more accurately identify and reflect an actual structure of the source code.

FIG. 1 is a visual representation of an example of this AST 20. Through the AST 20, the model may recognize more structural information than in training based on simple text 10, and use this structural information to generate more accurate and meaningful source code.

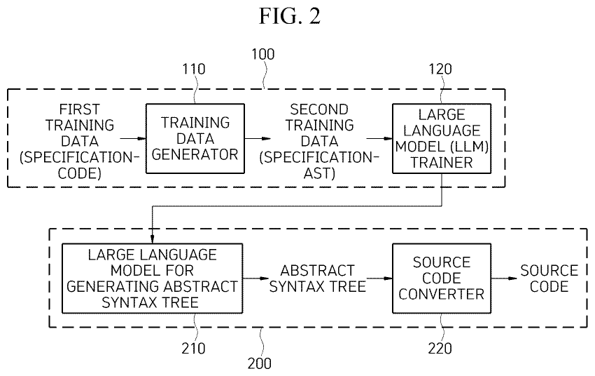

FIG. 2 is a diagram for describing the device 100 for automatically generating source code according to the embodiment of the present invention.

The device 100 for automatically generating source code according to the embodiment of the present invention may largely perform a training process and an inference process. First, the training process will be described in detail.

The device 100 for automatically generating source code according to the embodiment of the present invention includes a training data generator 110 and an LLM trainer 120.

Upon receiving first training data consisting of pairs of natural language specification and source code, the training data generator 110 converts the first training data into second training data consisting of a natural language specification and AST pair.

In this case, the training data generator 110 maintains the natural language specification among the first training data without change. This is to allow the LLM to understand and preserve the description of a given task. Then, the source code is parsed using a parser (e.g., a parser such as a tree-sitter), and an AST is generated based on the parsed source code. That is, the training data generator may analyze the parsed source code to understand a structure of the source code and generate an AST based on this structure.

The AST generated in this way is paired with the natural language specification to form new training data (second learning data).

Next, the LLM trainer 120 trains an LLM based on the second training data. In an embodiment, the LLM in the present invention may be a transformer having an encoder-decoder structure-based model or decoder-based GPT model.

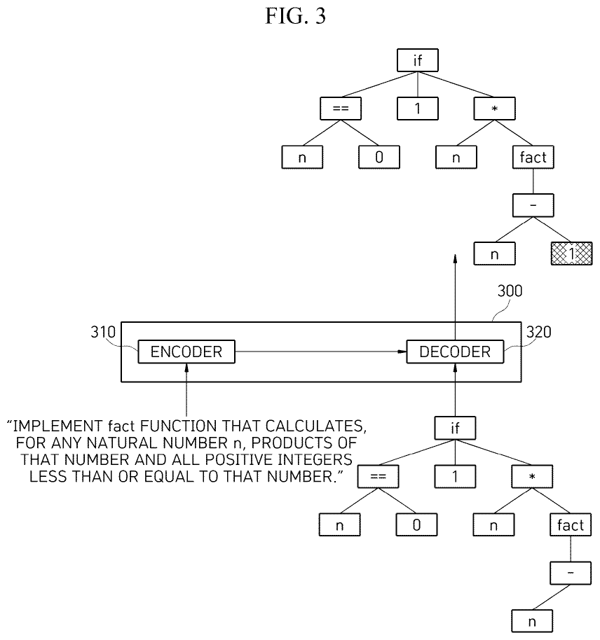

FIG. 3 is a diagram illustrating an example of training the transformer having an encoder-decoder structure-based LLM in an embodiment of the present invention.

In an embodiment of the present invention, the LLM may use an encoder-decoder structure based on a transformer architecture.

In an embodiment, an encoder 310 receives a natural language specification of the second training data and encodes the natural language specification of the second training data into a semantic vector. A decoder 320 sequentially generates nodes constituting an AST based on the encoded semantic vector.

At each stage, the decoder 320 is trained by predicting a next tree node and expanding the tree. That is, the LLM trainer 120 trains the LLM so that the decoder 320 generates a node corresponding to a first line of the AST and predicts a node corresponding to a second line located after the first line. This means that the decoder 320 predicts the next node by considering previously generated nodes, and maintains the context.

When learning is completed through a training stage, the trained LLM (hereinafter referred to as the learning LLM 210) is produced as a result.

In an inference stage, upon receiving a natural language specification, the learning LLM 210 outputs an AST. That is, the learning LLM 210 is a neural network that generates an AST that expresses a structure and logic of source code according to the natural language specification.

However, since the AST is not in the form of actual source code that a program can understand and execute, the AST can be used in a programming environment only after post-processing to convert the AST into source code is performed.

To this end, in an embodiment of the present invention, a source code converter 220 may be further included. The source code converter receives the AST output from the learning LLM 210, converts the AST into source code that a user or program can understand, and outputs the source code.

In an embodiment, the source code converter 220 may generate a source code component at each node by traversing the AST, and generate source code complying with a grammar structure of a target programming language based on the source code component.

That is, the source code converter 220 may extract an actual source code component corresponding to each terminal node while traversing the AST, and configure the actual source code component into accurate grammatical source code. For example, variables, operators, etc. may be arranged to comply with a grammar of a programming language.

Since the source code generated through the AST complies with the grammatical structure of the programming language, code that is structurally consistent and has fewer errors may be generated. This configuration enables use in a much more effective programming environment compared to the existing model that generates simple text. That is, in an embodiment of the present invention, through a combination of the learning LLM 210 and the source code converter 220, source code may be effectively generated from the natural language specification.

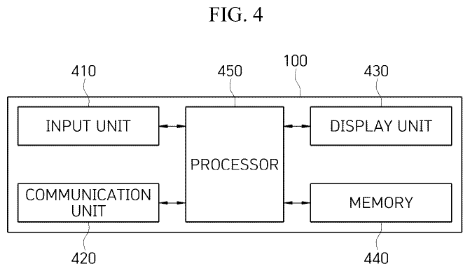

FIG. 4 is a block diagram of the device 100 for automatically generating source code according to the embodiment of the present invention.

Meanwhile, the device 100 for automatically generating source code according to the embodiment of the present invention includes an input unit 410, a communication unit 420, a display unit 430, a memory 440, and a processor 450.

The input unit 410 receives a natural language specification and source code as training data in a training process, or receives the natural language specification during a subsequent inference process. In addition, the input unit 410 generates input data in response to user input of the device 100 for automatically generating source code. The user input may include user input regarding data that the device 100 for automatically generating source code intends to process.

The input unit 410 may include at least one input means. The input unit 410 may include a camera, a microphone, a keyboard, a key pad, a dome switch, a touch panel, a touch key, a mouse, a menu button, etc.

The communication unit 420 transmits and receives data between internal components or performs communication with an external device such as an external server. This communication unit 420 may include both a wired communication module and a wireless communication module. The wired communication module may be implemented as a power line communication device, a telephone line communication device, a home cable (MoCA), the Ethernet, IEEE 1294, an integrated wired home network, or an RS-485 control device. In addition, the wireless communication module may be composed of modules to implement functions such as a wireless local area network (WLAN), Bluetooth, a high data rate wireless personal area network (HDR WPAN), a ultra wideband (UWB), ZigBee, Impulse Radio, 60 GHz WPAN, binary code division multiple access (Binary-CDMA), wireless Universal Serial Bus (USB) technology, wireless High Definition Multimedia Interface (HDMI) technology, 5G, long term evolution A (LTE-A), LTE, wireless fidelity (Wi-Fi), etc.

The display unit 430 displays display data in response to an operation of the device 100 for automatically generating source code. The display unit 430 may display input training data and inference results.

The display unit 430 includes a liquid crystal display (LCD), a light emitting diode (LED) display, an organic LED (OLED) display, a micro electro mechanical systems (MEMS) display, and an electronic paper display. The display unit 430 may be implemented as a touch screen by being combined with the input unit 410.

The memory 440 stores programs for configuring training data and performing the training and inference process of the LLM in the device 100 for automatically generating source code. Here, “memory 440” is a term for collectively referring to a non-volatile storage device that continue to retain stored information even when power is not supplied and a volatile storage device. For example, the memory 440 may include a NAND flash memory, such as a compact flash (CF) card, a secure digital (SD) card, a memory stick, a solid-state drive (SSD), and a micro SD card, a magnetic computer storage device such as a hard disk drive (HDD), an optical disc drive such as a compact disc read only memory (CD-ROM), a digital versatile disc-read only memory (DVD-ROM), etc.

The processor 450 may execute software such as a program to control at least one other component of the device 100 for automatically generating source code (e.g., a hardware or software component) and to perform various data processing processes or computations.

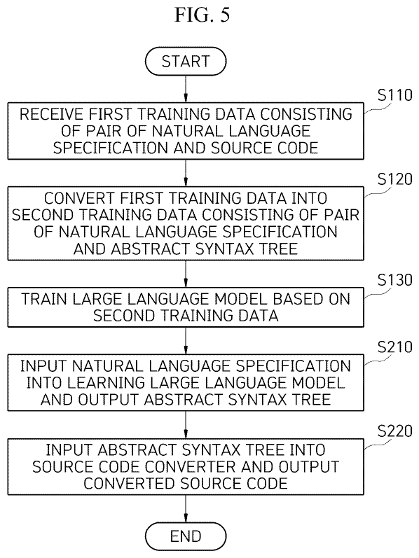

Hereinafter, a method of automatically generating source code performed by the device 100 for automatically generating source code will be described with reference to FIG. 5.

FIG. 5 is a flowchart of a method of automatically generating source code according to an embodiment of the present invention.

First, first training data consisting of pairs of natural language specification and source code is received (S110), and then the first training data is input into a training data generator and converted into second training data consisting of a natural language specification and AST pair (S120).

Next, an LLM is trained based on the second training data (S130).

After that, the natural language specification is input into the trained LLM and the AST is output (S210). The output AST is input into a source code converter and the converted source code is output (S220).

Meanwhile, in the above description, operations S110 to S220 may be further divided into additional operations or combined into fewer operations, depending on an implementation of the present invention. In addition, some operations may be omitted or the order between operations may be changed as needed. In addition, even for other omitted content, the content described in FIGS. 1 to 4 and the content described in FIG. 5 may be mutually applied to each other.

The method of automatically generating source code according to an embodiment of the present invention described above may be implemented as a program (or an application) and stored in a medium in order to be executed by being combined with a computer which is hardware.

The program described above may include code coded in a computer language such as C, C++, JAVA, Ruby, machine language, etc. that can be read by a processor (a central processing unit (CPU)) of the computer through a device interface of the computer in order for the computer to read the program and execute the methods implemented as programs. Such code may include functional codes related to a function that defines features required to execute the above methods, and may include control codes related to an execution procedure required for the processor of the computer to execute the above features according to a predetermined procedure. In addition, such code may further include memory reference-related codes that indicate from which location (memory address) of an internal or external memory of the computer additional information required for the processor of the computer to execute the above features or media should be referenced. In addition, when the processor of the computer needs to communicate with any other remotely located computer or server in order to execute the functions, the code may further include communication-related codes for how to communicate with any other remotely located computer or server using a communication module of the computer, what information or media should be transmitted and received during communication, etc.

The medium for storing data is a medium that stores data semi-permanently and can be read by a device, rather than a medium that stores data for a short period of time, such as a register, a cache, a memory, etc. Specifically, examples of the medium for storing data include, but are not limited to, a ROM, a RAM, a CD-ROM, a magnetic tape, a floppy disk, and an optical data storage device. That is, the program may be stored in various recording media on various servers that the computer can access or on various recording media on the user's computer. In addition, the medium may be distributed to computer systems connected to a network, and computer-readable code may be stored in a distributed manner.

The above description of the present invention is for illustrative purposes only, and those skilled in the art to which the invention pertains will understand that the present invention can be easily modified into other specific forms without changing its technical idea or essential features. Therefore, it should be understood that the embodiments described above are illustrative and not limiting in all respects. For example, each component described as single may be implemented in a distributed manner, and similarly, components described as distributed may also be implemented in a combined form.

According to an embodiment of the present invention described above, the present invention provides an innovative source code generation technology that breaks away from the traditional program source code learning method and is based on an abstract syntax tree. In an embodiment of the present invention, a structure and pattern in programming can be efficiently learned by clearly understanding and reflecting fundamental differences between natural language sentences and program code. In the code generated through this source code generation technology, high accuracy compared to the related art is observed and grammatical or logical errors are greatly reduced, and accordingly, high-quality code can be generated.

The scope of the present invention is defined by the claims described below rather than the detailed description above. The meaning and scope of the claims and all changes or modified forms derived from the equivalent concept thereof should be construed as being included in the scope of the present invention.

What is claimed is:

1. A method of automatically generating source code, which is performed by a computer, the method comprising:
receiving first training data consisting of a pair of natural language specification and source code;
inputting the first training data into a training data generator and converting the first training data into second training data consisting of a pair of natural language specification and abstract syntax tree; and
training a large language model based on the second training data,
wherein the abstract syntax tree includes structural information and semantic information of the source code.

2. The method of claim 1, wherein the inputting of the first training data into the training data generator and the converting of the first training data into the second training data consisting of the pair of natural language specification and abstract syntax tree includes:
maintaining the natural language specification among the first training data without change;
parsing the source code among the first training data; and
generating the abstract syntax tree based on the parsed source code.

3. The method of claim 1, wherein the large language model is either a transformer having a model having a structure of an encoder and a decoder or a decoder-based generative pre-trained transformer (GPT) model.

4. The method of claim 3, wherein the training of the large language model based on the second training data includes:
when the large language model is the transformer having the model having the structure of an encoder and a decoder,
training the large language model so that the encoder receives the natural language specification of the second training data and converts the natural language specification of the second training data into a semantic vector; and
training the large language model so that the decoder sequentially generates nodes constituting the abstract syntax tree based on the semantic vector.

5. The method of claim 4, wherein the training of the large language so that the decoder sequentially generates the nodes constituting the abstract syntax tree based on the semantic vector includes:
generating, by the decoder, a node corresponding to a first line; and
predicting, by the decoder, a node corresponding to a second line located next to the first line.

6. The method of claim 1, further comprising:
inputting a natural language specification into the trained large language model (hereinafter referred to as a learning large language model) and outputting an abstract syntax tree; and
inputting the output abstract syntax tree into a source code converter and outputting converted source code.

7. The method of claim 6, wherein the inputting of the output abstract syntax tree into the source code converter and the outputting of the converted source code includes:
generating a source code component at each node by traversing the abstract syntax tree; and
generating source code complying with a grammar structure of a target programming language based on the source code component.

8. A device for automatically generating source code, comprising:
a training data generator that receives first training data consisting of a pair of natural language specification and source code and converts the first training data into second training data consisting of a pair of natural language specification and abstract syntax tree; and
a large language model trainer that trains a large language model based on the second training data,
wherein the abstract syntax tree includes structural information and semantic information of the source code.

9. The device of claim 8, wherein the training data generator parses the source code while maintaining the natural language specification among the first training data without change and generates the abstract syntax tree based on the parsed source code.

10. The device of claim 8, wherein the large language model is either a transformer having a model having a structure of an encoder and a decoder or a decoder-based generative pre-trained transformer (GPT) model.

11. The device of claim 10, wherein when the large language model is the transformer having the model having the structure of an encoder and a decoder, the large language model trainer trains the large language model so that the encoder receives the natural language specification of the second learning data and converts the natural language specification of the second learning data into a semantic vector and the decoder sequentially generates nodes constituting the abstract syntax tree based on the semantic vector.

12. The device of claim 11, wherein the large language model trainer trains the large language model so that the decoder generates a node corresponding to a first line of the abstract syntax tree and predicts a node corresponding to a second line located next to the first line.

13. The device of claim 8, further comprising a source code converter that receives an abstract syntax tree output by inputting a natural language specification into the trained large language model (hereinafter referred to as a learning large language model) and outputs converted source code.

14. The device of claim 13, wherein the source code converter generates a source code component at each node by traversing the abstract syntax tree, and generates source code complying with a grammar structure of a target programming language based on the source code component.

15. A method of automatically generating source code, which is performed by a computer, the method comprising:
inputting a natural language specification into a pre-trained large language model (hereinafter referred to as a learning large language model) and outputting an abstract syntax tree including structural information and semantic information of source code; and
inputting the output abstract syntax tree into a source code converter and outputting converted source code,
wherein the learning large language model is trained based on training data consisting of a pair of natural language specification and abstract syntax tree prepared in advance.

16. The method of claim 15, wherein the inputting of the output abstract syntax tree into the source code converter and the outputting of the converted source code includes:
generating a source code component at each node by traversing the abstract syntax tree; and
generating source code complying with a grammar structure of a target programming language based on the source code component.
